(19) United States
(12) Patent Application Publication
(10) Pub. No.: US 2022/0292483 A1
(43) Pub. Date: Sep. 15, 2022

(54) SAFE MOBILE PAYMENT PLATFORM

(71) Applicant: PAYCORE ÖDEME HIZMETLERI TAKAS VE MUTABAKAT SISTEMLERI A. S., Istanbul (TR)

(72) Inventors: Ibrahim DURAK, Istanbul (TR); Ahmet AKGÜN, Istanbul (TR)

(21) Appl. No.: 17/415,911

(22) PCT Filed: Dec. 29, 2020
(86) PCT No.: PCT/TR2020/051437

§ 371 Date: Jun. 18, 2021

(30) Foreign Application Priority Data
Jan. 6, 2020 (TR) 2020/00106

(51) Int. Cl. G06Q 20/32; G06Q 40/00; G06Q 20/38

(52) U.S. Cl. CPC G06Q 20/327; G06Q 40/12; G06Q 20/38215

(57) ABSTRACT

The system which provides formation of fiscal data and its inspection for the payment methods wherein it comprises; Terminal (20) which is composed of devices used by the taxpayer/job site which will form the fiscal data related to receiving the payment and processing, and which determines the payment method, Fiscal module (27) which is present on the terminal (20) and which provides formation of fiscal information, carrying out of certificate and signature management, Basic sales application (23) which is present on the terminal (20) and which defines the product/division information so as to implement the sales transaction of the job site, and which forms the information related to the sales by using the data which it had defined during the sale, Terminal (20) software module in which all terminal software modules (24) are located, Authorization/approval hosts (30) which meets and feeds back the replies of the approval requests which the establishment giving the service must receive from its systems for payment transactions and added value services of the terminal (20), Central safe mobile payment platform (10) which provides fiscal certificate management related to the terminal (20) on which the sales has been performed, Back office software module (11) which is located on the safe mobile payment platform (10) and which provides face up for making customer and terminals (20) definitions to the system, which offers operator screens for monitoring the system and which provides preparation of awaited reports by receiving report demands, Fiscal data transmission module (12) which is located on the safe mobile payment platform (10) and which provides transmission of fiscal data to the Income Authority Official Corporation (40) with regulation approved content and timing via special integrators (41), Certificate management module (13) which is located on the safe mobile payment platform (10) and which performs certificate management belonging to terminals (20), Online message processing module (14) which is located on the safe mobile payment platform (10) and which meets the transactions starting from the terminal (20) to be done real time/online, which transmits to the respective sides and which receives their replies, which feeds back the replies to the terminal (20) and which records the information required for the transaction on server side.

### TECHNICAL FIELD

The invention relates to a system and method which provide fiscal data formation and inspection for different payment methods.

### PRESENT STATE OF THE ART

There exists no fiscal approved method among some existing payment methods and fiscal data formation inspection mechanisms. For example, while only physical payment can be received with a credit card cash register (CR) integrated pos (eft-pos with wired connection CR with a CR or GMP3 (Presidency of Income Messaging Protocol Division 3) having integrated eft-pos feature rules), with new payment technologies such as mobile payments, electronic wallet payments there is not any hierarchic system which is directly compatible for fiscal regulation among fiscal data formation. As per fiscal legislation, for all payment transactions, before sales details start it is compulsory to form a track record in a fiscal system and to complete the result of the transaction by matching with this track record. In the present methods other than CR, start track records are not being formed, and transfer of payment related information to the fiscal system (making out an invoice, accounting system declaration, income tax and VAT assessments, etc.) is being carried out by being prone to both ill will (not making out an invoice, making out an invoice in the name of someone else and unfair incentives/ benefiting from tax reductions, etc.) and also prone to error.

The abstract of application number 2017/05111 which emerged as a result of technical research quotes “The invention relates to a customer preparing the goods or services that he will purchase in electronic medium and selecting the payment choice on payment screen, electronic money and cash payment system implemented by payment by telephone method or credit purchasing method or loading credits on a telephone number method or purchasing pre-payment card method or mobile application or usage of official site method or agreement with mobile operator companies method.”.

As can be seen, the system is related to an electronic money and cash payment system, without mentioning a configuration which can provide a solution to the above mentioned disadvantages besides this. Consequently, it has been necessary to perform an improvement in the related technical field due to the negativities narrated above and because of the inadequacy of existing solutions on the subject.

### THE OBJECT OF THE INVENTION

The invention aims at setting forth a structure having different technical features which bring about a new opening in this field being different from the configurations in the prior art.

The prioritized object of the invention is to form a fiscal data formation/inspection mechanism for all existing payment methods that is suitable for fiscal legislation.

An object of the invention is to set forth a method which eliminates the conditions of management of fiscal certificates on the devices not being safe, being difficult or impossible; and which enables continuous functionality.

Another object of the invention is to set forth a method in which track record is formed first from the fiscal system for all payment methods and being compatible with the legislation.

Another object of the invention is to offer central server/terminal fiscal application design and task distribution which provides both meeting requirements related to fiscal regulation and also which provides operability at high level and which reduces operational problem potential and which provides ease in intervention.

The system and method of the invention includes fiscal record, data transmission and reporting solution with a server module (safe payment platform) that meets these devices that are embedded on being conjugate of fiscal memory, electronic recording unit that are present on cash registers, which lack dedicated components such as customer oriented screen, to be used for the purpose of programmable payment devices (terminals). The invention offers an interface which can be integrated to the system to the payment side in a manner to implement fiscal function related to all payment methods that are up to date and which could arise afterwards. It comprises an integrated safe fiscal solution formed by two modules that will work in a conjugate manner on the terminal and on the server side. The fiscal safety mechanism offered by the invention has been designed to be modified only by making adjustments upon need to be operable on terminal module and/or on server module.

The invention is a system which provides the formation and inspection of fiscal data for payment methods in order to carry out the above mentioned objects wherein it comprises;
terminal which is composed of devices used by the taxpayer/job site which will form the fiscal data related to receiving the payment and processing, and which determines the payment method,
fiscal module which is present on the terminal and which provides formation of fiscal information, carrying out of certificate and signature management,
basic sales application which is present on the terminal and which defines the product / division information so as to implement the sales transaction of the job site, and which forms the information related to the sales by using the data which it had defined during the sale,
terminal software module in which all terminal software modules are located,
crypto transactions module which carries out cryptographic functions such as receiving certificate/key, keeping, using, signing, coding, and verification,
workflow module which provides management of hierarchically all steps in sequence from the start to the conclusion of the sale.
user interface module which forms the entire screens of information, data input which the end user will see on the terminal,
host protocol module in which messaging protocols of authorization hosts are realized,
authorization/approval hosts which meets and feeds back the replies of the approval requests which the establishment giving the service must receive from its systems for payment transactions and added value services of the terminal,
central safe mobile payment platform which provides fiscal certificate management related to the terminal on which the sales has been performed,
back office software module which is located on the safe mobile payment platform and which provides face up for making customer and terminals definitions to the system, which offers operator screens for monitoring the system and which provides preparation of awaited reports by receiving report demands,
fiscal data transmission module which is located on the safe mobile payment platform and which provides transmission of fiscal data to the income authority official corporation with regulation approved content and timing via special integrators,
certificate management module which is located on the safe mobile payment platform and which performs certificate management belonging to terminals, signature inspections and cryptography management to be performed by using certificates in transactions messages,
online message processing module which is located on the safe mobile payment platform and which meets the transactions starting from the terminal to be done real time I online, which transmits to the respective sides and which receives their replies, which feeds back the replies to the terminal and which records the information required for the transaction on server side.

Structural and characteristic features of the invention and all of its advantages will be understood more clearly by means of the figures given below and the detailed description written by referring to these figures and therefore it should be appreciated by considering these figures and this detailed description.

### THE FIGURES WHICH WILL AID FOR BETTER UNDERSTANDING OF THE INVENTION

FIG. 1 is the overall view of the system of the invention.

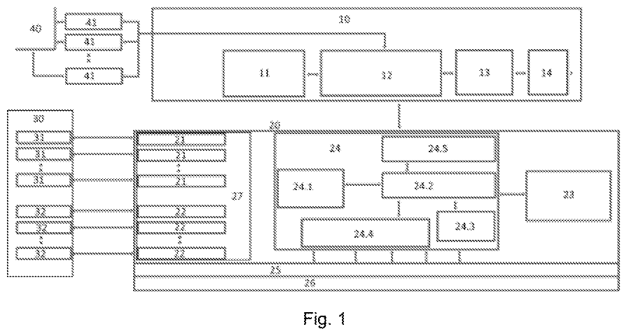

The drawings must certainly be scaled and details which are not required to understand the present invention can be neglected. Other than this, elements which are substantially identical, or which have at least substantially identical functions are designated with the same numbers.

### EXPLANATION OF PART REFERENCES

10. Safe mobile payment platform
11. Back office module
12. Fiscal data transmission module
13. Certificate management module
14. Online message processing module
20. Terminal
21. Payment applications
22. VAS applications
23. Basic sales applications
24. Terminal software module
24.1 Crypto transactions module
24.2 Workflow module
24.3 User interface module
24.4 Hardware abstraction module
24.5 Host protocol module
25. Lower level layer
26. Hardware layer
27. Fiscal module
30. Authorization hosts (approval hosts)
31. Payment host
32. VAS host
40. income Authority Official Corporation
41. Private integrator

### DETAILED DESCRIPTION OF THE INVENTION

In this detailed description, preferred configurations of the invention are described aimed at only better understanding of the subject and without forming any limiting effects.

In the system and method of the invention, sales is being performed via terminal (20) and fiscal certificate management related to the terminal (20) on which sales has been performed is being performed on the application in the servers of central safe payment platform (10).

Terminal (20) is all kinds of devices such as telephone, tablet, computer, eft - pos which are used by the taxpayer (job site) who will receive the payment and will form the fiscal data related to the transaction. In other words, terminals (20) are utterly different pool of terminals far away from the safe mobile payment platform (10), working on hardware in various job sites. Payment method is being determined at the terminal (20), Payment method is a system solution which provides technical infrastructure to the payment of independent (Cash, actual or virtual payment with card, meal cheque, social help cheque, etc.) procurement of goods or services, which produces fiscal data related to the payment in a suitable manner to fiscal legislation, which transmits and stores it compatible with the regulation.

Fiscal module (27) located at the terminal (20) provides formation of fiscal information and performing certificate and signature management. According to the payment method determined at the terminal (20) authorization/approval is being received from the authorization hosts (30) which are related to payment applications (21) or VAS applications (22) that are located at the fiscal module (27). Payment application (21) is the terminal (20) application that sends the information about the payment transaction which is prepared for the establishment that is intervening with the payment or banks that accept (acquire) the payment with card to the respective establishment and receiving their approval, It is necessary to receive authorization for all transactions except for cash payments. Payment acceptance is being received from the bank for the card, from the respective meal card companies for the meal card, from the bank for the debit card, and from respective companies for the transportation card. Approval/authorization are being received from için l5 the respective payment host (31) for payment application (21), and from the VAS host (31) for the VAS application (22). (VAS: Value Added Services). VAS applications (22) are applications that meet the special requirements for various lines of business but that do not form financial I fiscal data in their own structure. (For example, a parking lot management application provides parking lot establishment to carry out their work by managing the information such as license plate number, parking time, subscription, reduction, exit time, parking location/unit, registration number of incumbent employee and kind of payment of parked vehicles; and a complete solution is provided at the same terminal (20) which has been provided with both work flow, and financial activity (payment) and also fiscal data management by means of the other modules on the terminal (20).)

The basic sales application (23) located at the terminal (20) is the user application module which defines the product/division information for implementing the sales transaction of the job site, and which forms the information related to the sales (such as which product, in which quantity, in which amount from which division is being sold) by using the data that it has defined during the sale.

Terminal software module (24) is the collective name for all terminal software modules developed to implement the invention.

Crypto transactions module (24.1) is the module which carries out cryptographic functions such as acquiring certificate I key, storing, using, signing, coding, and verification.

Workflow module (24.2) is the flow module which provides hierarchically the management of all steps in sequence from the start of the sales until the end of it. It makes decisions such as proceeding to the next stage or cutting off the transaction by requesting the respective module for the transaction whose turn has come and collecting result data and evaluating them.

User interface module (24.3) is the visual software layer for all screens such as information, data entry which the end user (job site and consumer) will see on the terminal (20)

Hardware abstraction module (24.4) is the intermediate layer software which provides unchangeableness of the software at the upper level for different hardware, and which comprises the suitable software related to the differences of hardware.

Host protocol module (24.5) is the software layer on which messaging protocols of the authorization hosts (30) are being realized.

Lower level layer (25) is low level software modules which offer the infrastructure that the upper level applications such as operating system, device drivers and software libraries will use.

Hardware layer (26) is the physical hardware of the user as the terminal (20).

Authorization hosts (approval hosts) (30) are server systems which meet approval requests that are required to be received from the systems of the respective establishment for the payment transactions and value added services of the terminal (20), and which feeds back the replies of the same.

Payment host (31) is the server module of the systems belonging to the sides that give payment services. And the VAS host (32) is the server module of the systems belonging to the sides that give value added services.

Fiscal certificate management related to the terminal (20) at which sales has been made is being done by the central safe mobile payment platform (10). In the back office software module (11) which is located at the safe mobile payment platform (10), face up is being provided for carrying out definitions of customer and terminals (20) to the system; operator screens are being offered for monitoring the system; and preparation of awaited reports is being provided by receiving report demands. That is to say, back office software module (11) is the module which comprises all components of the integration of the platform that are not real time, user screens on the server side.

In the fiscal data transmission module (12) located at the safe mobile payment platform (10) transmission of the fiscal data with regulation defined content and with timing to the Income Authority Official Corporation (40) via special integrators (41). Income Authority Official

Corporation (40) is the public systems that fiscal data must reach as per the requirements of the regulation. Presidency of Income Authority can be given as an example to the Income Authority Official Corporation (40). And the special integrator (41) is e-document system equity houses whose activity rules and liabilities have been determined by public regulation.

And in the certificate management module (13) which is located in the safe mobile payment platform (10) certificate management belonging to the terminals (20), signature checks to be done by using certificates in the transaction messages and cryptography management are being carried out. Also, in the certificate management module (13) certificate acquiring and utilization works such as transmission of fiscal data which the system is in need of, signing, verification, message coding are being carried out too.

The online message processing module (14) located at the safe mobile payment platform (10) is the software module which meets the transactions to be done real time/online starting from the terminal (20), transmits to the related parties and receives their replies, feeds back the replies to the terminal (20) and records the information required for the transaction on the server side,

The process steps implemented by the system of the invention are the following;
defining the job site which will use the safe mobile payment platform (10) via back office software module (11),
implementing prerequisites by the certificate management module (13) that are required for the operation of certificate production process for the terminal/terminals (20) that the job site will use, and for the set-up of software modules that will work on the terminal (20) (version definition, user and code definitions, single use verification definitions, etc.),
setting-up fiscal module (27) and basic sales application (23) which will work on the terminal (20),
completing technical preliminary preparations that are required for safely inclusion of fiscal module (27) and basic sales application (23) to the system, and for enabling sales transaction by using the verification methods that have been determined at the certificate management module (13),
configurating the fiscal module (27) and the basic sales application (23), (cashier/user definitions, tax groups' definitions, product definitions, etc, are being implemented at this stage.)
selecting products/amounts in tax segments in the fiscal module (27) to do the sales transaction, and following formation of the fiscal activity implementation of the payment by the methods supported by the system, (while in methods such as cash it is implemented between the seller and buyer, in the methods of payments with card or meal cheque technical messaging which will provide authorization online from the respective approval bodies is being used) and transfer of successful/unsuccessful (cancel/abort) fiscal data to gmö platform are implemented.
transmitting the fiscal data by the terminal software module (24) momentarily to the safe mobile payment platform (10) in routine intervals determined by the regulation or in line with the momentary requests of the regulator (such as momentary transaction information, daily z-reports, weekly or monthly z-reports),
transmitting the fiscal data from the safe mobile payment platform (10) to the income authority official corporation (40).

1. A system which provides formation of fiscal data and inspection for the payment methods, the system comprising:
a terminal which is composed of devices used by a taxpayer/job site which will form fiscal data related to receiving payment and processing, and which determines a payment method:
a fiscal module which is present on the terminal and which provides formation of fiscal information, carrying out of certificate and signature management;
a basic sales application which is present on the terminal and which defines product/division information so as to implement sales transaction of the job site, and which forms information related to the sales by using the data which it had defined during the sale;
a terminal software module in which all terminal software modules are located;
a crypto transactions module which carries out cryptographic functions such as receiving certificate/key, keeping, using, signing, coding, and verification;
a workflow module which provides management of hierarchically all steps in sequence from the start to the conclusion of the sale;
a user interface module which forms the entire screens of information, data input which the end user will see on the terminal;
a host protocol module in which messaging protocols of authorization hosts are realized;
authorization/approval hosts which meets and feeds back the replies of the approval requests which the establishment giving the service must receive from its systems for payment transactions and added value services of the terminal;
a central safe mobile payment platform which provides fiscal certificate management related to the terminal on which the sales has been performed;
a back office software module which is located on the safe mobile payment platform and which provides face up for making customer and terminals definitions to the system, which offers operator screens for monitoring the system and which provides preparation of awaited reports by receiving report demands;
a fiscal data transmission module which is located on the safe mobile payment platform and which provides transmission of fiscal data to the income authority official corporation with regulation approved content and timing via special integrators;
a certificate management module which is located on the safe mobile payment platform and which performs certificate management belonging to terminals, signature inspections and cryptography management to be performed by using certificates in transactions messages;
an online message processing module which is located on the safe mobile payment platform and which meets the transactions starting from the terminal to be done real time/online, which transmits to the respective sides and which receives their replies, which feeds back the replies to the terminal and which records the information required for the transaction on server side.

2. The system according to claim 1, comprising the payment application which is prepared for the establishments that intervene with the payment or for the banks that accept payment by card, which sends the information about the payment transaction to the respective establishment and receives their approval, and which is located in the fiscal module.

3. The system according to claim 1, comprising the VAS application which meets special requirements for various lines of business, and which does not form financial/fiscal data in its own structure.

4. The system according to claim 1, comprising the hardware abstraction module which provides unchangeableness of the software at the upper level for different hardware, and which comprises the suitable software related to the differences of hardware.

5. The system according to claim 1, comprising the lower level layer composed of low level software modules, and which offer the infrastructure that the upper level applications such as operating system, device drivers and software libraries will use.

6. The system according to claim 1, comprising the hardware layer t26)-which forms the physical hardware of the user as terminal.

7. The system according to claim 1, comprising the payment host which communicates with the payment application and which is the server module of the parties that offer payment services.

8. The system according to claim 1, comprising the VAS host which communicates with VAS application and which is the server module of the parties that offer value added services.

9. A method which provides formation and inspection of fiscal data for the payment methods, comprising the process steps of:
defining a job site which will use a safe mobile payment platform via a back office software module;
implementing prerequisites by a certificate management module that are required for the operation of certificate production process for terminal/terminals that the job site will use, and for set-up of software modules that will work on the terminal;
setting-up fiscal module and basic sales application which will work on the terminal;
completing technical preliminary preparations that are required for safely inclusion of the fiscal module and basic sales application to the system, and for enabling sales transaction by using verification methods that have been determined at the certificate management module;
configuring the fiscal module and the basic sales application;
selecting products/amounts in tax segments in the fiscal module to do the sales transaction, and following formation of the fiscal activity implementation of the payment by the methods supported by the system;
transmitting the fiscal data by the terminal software module momentarily to the safe mobile payment platform in routine intervals determined by the regulation or in line with the momentary requests of the regulator;
transmitting the fiscal data from the safe mobile payment platform to the an income authority official corporation.
